(19) United States
(12) Patent Application Publication
(10) Pub. No.: US 2024/0081361 A1
(43) Pub. Date: Mar. 14, 2024

(54) COLORATION INHIBITOR, METHOD FOR PRODUCING COLORATION INHIBITOR, EDIBLE OIL AND FAT COMPOSITION, AND METHOD FOR INHIBITING COLORATION OF FOOD PRODUCT

(71) Applicant: J-OIL MILLS, INC., Tokyo (JP)

(72) Inventors: Takehiko SEKIGUCHI, Tokyo (JP); Ayako MAEDA, Tokyo (JP); Masami INOUE, Tokyo (JP)

(21) Appl. No.: 18/272,267

(22) PCT Filed: Jan. 13, 2022
(86) PCT No.: PCT/JP2022/000978

§ 371 Date: Jul. 13, 2023

(30) Foreign Application Priority Data
Jan. 27, 2021 (JP) 2021-010802

(51) Int. Cl. A23D 9/04

(52) U.S. Cl. CPC A23D 9/04

(57) ABSTRACT

A coloration inhibitor characterized in containing, as an active ingredient, a heated oil obtained by implementing a heating treatment at 120° C. or higher on: an unrefined raw oil including an expressed oil of an oil and fat raw material, an extracted oil of the oil and fat raw material, or both the expressed oil and the extracted oil; or an oil and fat obtained by furthermore implementing degumming, deacidification, or both of these treatments on the unrefined raw oil. The coloration inhibitor is suitably used as an edible ingredient for inhibiting coloration of an edible oil and fat composition or inhibiting coloration of a food product cooked using the edible oil and fat composition.

### TECHNICAL FIELD

The present invention relates to a technique for inhibiting coloration of an edible oil and fat composition or inhibiting coloration of a food product cooked using the edible oil and fat composition.

### BACKGROUND ART

When a food ingredient is fried using rapeseed oil, soybean oil, or another edible oil and fat, the edible oil and fat becomes colored due to a heating operation or the effects of oxygen or moisture within the food ingredient or the atmosphere. As coloration of the edible oil and fat progresses, the quality of fried articles obtained therewith worsens, therefore making it impossible to use the edible oil and fat over an extended period.

Patent Document 1 discloses, as related art for inhibiting heating coloration of an edible oil and fat when a food product is fried using the edible oil and fat, a method in which a phosphorus-derived component of any of an expressed oil, an extracted oil, or a degummed oil is added to a refined edible oil and fat to obtain an oil and fat composition for fried foods, thereby improving the heating resistance of the refined edible oil and fat. Employing the oil and fat composition for fried foods results in improved heating stability and makes it possible to inhibit heating coloration and heating odor in particular.

### RELATED ART DOCUMENTS

### Patent Documents

[Patent Document 1] Japanese Laid-Open Patent Application No. 2009-050234

### DISCLOSURE OF THE INVENTION

### Problems the Invention is Intended to Solve

However, in view of the preferences of consumers and increasingly diverse needs of enterprises involved in the foodstuffs trade, it has become desirable to provide non-conventional edible ingredients.

It is accordingly an object of the present invention to provide an ingredient with which it is possible to inhibit coloration of an edible oil and fat composition or inhibit coloration of a food product cooked using the edible oil and fat composition.

### Means for Solving the Problems

As a result of thorough investigations, the inventors discovered that using a heated oil obtained by implementing a heating treatment at 120° C. or higher on an oil and fat having a specific degree of refinement makes it possible to solve the aforementioned problem, thereby perfecting the present invention. Specifically, the present invention is as described below.

[1] A coloration inhibitor characterized in containing, as an active ingredient, a heated oil obtained by implementing a heating treatment at 120° C. or higher on: an unrefined raw oil including an expressed oil of an oil and fat raw material, an extracted oil of the oil and fat raw material, or both the expressed oil and the extracted oil; or an oil and fat obtained by furthermore implementing degumming, deacidification, or both of these treatments on the unrefined raw oil.

[2] The coloration inhibitor according to [1], containing, as an active ingredient, a heated oil obtained by furthermore implementing a refinement treatment on the heated oil after implementation of the heating treatment at 120° C. or higher.

[3] The coloration inhibitor according to [1] or [2], wherein the oil and fat raw material is a vegetable oil and fat.

[4] An edible oil and fat composition characterized in containing the coloration inhibitor according to any of [1] to [3].

[5] A method for producing a coloration inhibitor, characterized in comprising a step for obtaining a heated oil by implementing a heating treatment at 120° C. or higher on: an unrefined raw oil including an expressed oil of an oil and fat raw material, an extracted oil of the oil and fat raw material, or both the expressed oil and the extracted oil; or an oil and fat obtained by furthermore implementing degumming, deacidification, or both of these treatments on the unrefined raw oil.

[6] The method for producing a coloration inhibitor according to [5], comprising a step for furthermore implementing a refinement treatment on the heated oil after implementation of the heating treatment at 120° C. or higher.

[7] The method for producing a coloration inhibitor according to [5] or [6], wherein the oil and fat raw material is a vegetable oil and fat.

[8] A method for inhibiting coloration of a food product, characterized in that the coloration inhibitor according to any of [1] to [3] is used when producing a food product.

[9] A method for inhibiting coloration of a food product, characterized in that the coloration inhibitor according to [8] is used when producing a food product.

### Effect of the Invention

According to the coloration inhibitor provided by the present invention, for example, frying a food ingredient using an edible oil and fat composition containing the coloration inhibitor makes it possible to provide a food product in which coloration caused by the edible oil and fat composition is inhibited.

Such coloration caused by the edible oil and fat composition can be objectively assessed through, e.g., a method for analytically testing chromaticity using a chromometer or the like, the method having ensured quantitative properties.

### MODE FOR CARRYING OUT THE INVENTION

The present invention uses, as an active ingredient of a coloration inhibitor, a heated oil obtained by implementing a heating treatment at 120° C. or higher on: an unrefined raw oil including an expressed oil of an oil and fat raw material, an extracted oil of the oil and fat raw material, or both the expressed oil and the extracted oil; or an oil and fat obtained by furthermore implementing degumming, deacidification, or both of these treatments on the unrefined raw oil.

The oil and fat raw material is not particularly limited. Examples thereof include vegetable oils and fats made from soybeans, coconuts, palm fruit, rapeseed, rice bran, corn, cottonseed, safflower, sunflower, olives, linseed, peanuts, sesame seeds, perilla seeds, pumpkin seeds, almonds, and the like. Among these, it is preferable to use one or more selected from the group consisting of soybeans, rapeseed, corn, and cottonseed, and more preferable to use one or more selected from the group consisting of soybeans, rapeseed, and corn, from the standpoint of further inhibiting coloration of a food product.

For the unrefined raw oil, it is permissible to use, e.g., an expressed oil obtained by pressing the oil and fat raw material or an extracted oil obtained through extraction from the oil and fat raw material. It is also permissible to use, e.g., a combination obtained by mixing the expressed oil and the extracted oil as the unrefined raw oil.

There is no particular limitation as to the pressing method. For example, pressing can be carried out using, inter alia, an expeller-type press composed of a cylindrically formed casing and a screw that is rotatably provided inside the casing.

There is no particular limitation as to the extraction method. For example, extraction is carried out by, inter alia, bringing a solvent into contact with a residue that remains after the oil and fat raw material is flattened or pressed and extracted, and then distilling away the solvent from a solution obtained through extraction from the resultant material to obtain an oil fraction. Examples of the solvent used during extraction include hexane and the like.

Ordinarily, when an edible oil and fat is produced, there are cases where the edible oil and fat passes through steps for removing impurities or the like that are contained in the unrefined raw oil. Such refinement steps include, e.g., a degumming step, a deacidification step, a decoloration step, and a deodorization step, as described below.

The degumming step involves hydrating and removing a gum substance that principally contains a phospholipid included in the oil fraction. Specifically, in the degumming step, water vapor or water is added to the unrefined raw oil, and the resulting combination is stirred.

The gum substance included in the unrefined raw oil thereby migrates to a water layer upon being hydrated. Therefore, removing the water layer removes the gum substance from the unrefined raw oil. The degumming step may be performed by adding a degumming agent. It is permissible to use, e.g., a substance composed of an aqueous solution of an organic acid such as oxalic acid, citric acid, or phosphoric acid as the degumming agent.

The deacidification step involves removing free fatty acids included in the unrefined raw oil as a soap fraction. The deacidification step can be performed by, e.g., treating the unrefined raw oil using an aqueous solution in which an alkaline substance such as sodium carbonate or caustic soda is dissolved in water.

The free fatty acids included in the unrefined raw oil are hydrolyzed using the aforementioned alkaline aqueous solution and form a soap. Removing the soap from the unrefined raw oil removes the free fatty acids from the unrefined raw oil.

The deacidification step is not limited to treating the unrefined raw oil using an alkali aqueous solution, and can also be performed through, e.g., a physical refinement method. Examples of the physical refinement method include steam distillation and molecular distillation.

The decoloration step involves removing pigments included in the unrefined raw oil. The decoloration step can be performed by, e.g., adsorbing the pigments onto activated white earth, activated carbon, or the like. The activated white earth or the like to which the pigments have bonded is removed through, e.g., reduced-pressure filtration.

The deodorization step involves removing odoriferous components included in the unrefined raw oil. The deodorization step can be performed by, e.g., carrying out steam distillation under reduced pressure.

In the present invention, an unrefined raw oil including an expressed oil, an extracted oil, or the like is used, as described above, but it is also permissible to use an oil and fat that has furthermore passed through the degumming step or the deacidification step. An “oil and fat that has passed through the degumming step” refers to an oil and fat obtained by subjecting the unrefined raw oil to the degumming step. An “oil and fat that has passed through the deacidification step” refers to an oil and fat obtained by subjecting the unrefined raw oil to the deacidification step. The oil and fat that has passed through the deacidification step may be obtained by, e.g., subjecting the unrefined raw oil to the degumming step and then to the deacidification step.

In the present invention, a heating treatment is implemented on the unrefined raw oil described above, or on an oil and fat that has a specific degree of refinement and that has passed through one or both of the degumming step and the deacidification step in the steps for refining the unrefined raw oil, the heating treatment being performed at 120° C. or higher, preferably 130° C. or higher and 220° C. or lower, and more preferably 140° C. or higher and 190° C. or lower. The heating treatment is carried out in a higher temperature zone than that used in, e.g., a heating treatment performed in the refinement steps for refining the unrefined raw oil, said heating treatment being performed at about 100° C. In the present description, in order to distinguish between the heating treatment performed in the refinement steps or the like and the heating treatment performed at 120° C. or higher, the heating treatment performed at 120° C. or higher is referred to as a superheating treatment. The heated oil subjected to the superheating treatment is referred to as a superheated oil.

In a step for obtaining the superheated oil, the superheating treatment is preferably carried out under conditions derived according to formula (1).

35≤(T−100)×t^{0.2}0.2≤270 Formula (1):

In the formula, T is the heating temperature, and t is the treatment time (minutes).

When the heating temperature is 140° C. or higher, it is preferable to carry out the heating treatment at least until that temperature is reached. In this case, because t may be a time exceedingly close to 0, it is permissible not to conform to the conditions in formula (1). For example, when the heating temperature is 140° C. or higher, the treatment time may be set to 0 minutes (with the treatment being ended once the heating temperature (140° C. or higher) is reached), etc.

The treatment time is the time for which the oil and fat is substantially kept at the treatment temperature once the oil and fat has been heated and reached the treatment temperature.

The coloration inhibitor provided by the present invention may be configured from only the aforementioned superheated oil or may be configured from a substance obtained by mixing the aforementioned superheated oil with an ordinary edible oil and fat. Alternatively, the coloration inhibitor may be configured from a superheated oil obtained by furthermore implementing a refinement treatment on the aforementioned superheated oil or a substance obtained by mixing the refined superheated oil with an edible oil and fat. In the latter case, as described above, the refinement steps include removing impurities or the like that are contained in the oil fraction, and may include, e.g., a degumming step, a deacidification step, a decoloration step, and a deodorization step. The coloration inhibitor may also contain food product additives that correspond to the application or object of the coloration inhibitor.

According to another non-limiting embodiment of the present invention, the present invention provides an edible oil and fat composition containing the coloration inhibitor described above.

The edible oil and fat is not particularly limited. Examples thereof include: rapeseed oil, corn oil, soybean oil, palm olein, sesame oil, peanut oil, safflower oil, sunflower oil, cottonseed oil, grapeseed oil, macadamia nut oil, hazelnut oil, walnut oil, pumpkinseed oil, camellia oil, tea oil, olive oil, rice bran oil, wheat germ oil, palm oil, palm kernel oil, coconut oil, cacao butter, and other vegetable oils and fats; beef tallow, pig lard, chicken fat, milk fat, fish oil, and other animal oils and fats; and medium-chain fatty acid triglycerides and other synthetic oils and fats.

It is also possible to use a processed oil and fat obtained by performing one or more treatments selected from among hydrogenation, fractionation, and transesterification on the aforementioned vegetable oils and fats, animal oils and fats, or synthetic oils and fats. One or more of these edible oils and fats can be used.

In the present invention, when the coloration inhibitor configured from the superheated oil or the like described above is used in the form of an edible oil and fat composition blended with the edible oil and fat, the amount blended with the edible oil and fat is not particularly limited; if the superheated oil is used as an index, the superheated oil is preferably contained in an amount of 0.001 parts by mass or more and 10 parts by mass or less, more preferably contained in an amount of 0.005 parts by mass or more and 7 parts by mass or less, and even more preferably contained in an amount of 0.01 parts by mass or more and 5 parts by mass or less per 100 parts by mass of the edible oil and fat.

The coloration inhibitor configured from the superheated oil or the like, or the edible oil and fat composition containing the same, that is provided by the present invention is capable of inhibiting coloration of the oil and fat during cooking with heat and, when a fried food or the like is cooked using the edible oil and fat composition, makes it possible to inhibit coloration of a food product caused by the edible oil and fat composition. Specifically, it is possible to inhibit coloration of the edible oil and fat composition during cooking with heat or to inhibit coloration of a food product caused thereby.

There is no particular limitation as to the food product to which the present invention is applied. Examples thereof include tempura, French fries, hash browns, croquettes, kara-age, fried pork cutlet, fried fish, corn dogs, chicken nuggets, deep-fried tofu, doughnuts, deep-fried bread, fried rice crackers, snack foods, instant ramen, and other deep-fried foods. Among these, fried chicken, kara-age, and fried pork cutlet are preferred, and fried chicken and kara-age are more preferred.

### EXAMPLES

The present invention is described in detail below based on examples but is in no way limited by these examples.

(Edible Oil and Fat)

Examples of the edible oil and fat used in the present example are given below.

(Base Oil)
Canola oil: J-canola oil, made by J-Oil Mills, Inc.
Soybean oil: J-soybean oil purified oil, made by J-Oil Mills, Inc.

(Vegetable Oil and Fat)
Expressed corn oil: made by Ohta Oat Mill Co., Ltd.
Degummed corn oil: made by J-Oil Mills, Inc.
Deacidified corn oil: made by J-Oil Mills, Inc.
Extracted soybean oil: made by J-Oil Mills, Inc.
Degummed soybean oil: made by J-Oil Mills, Inc.
Deacidified soybean oil: made by J-Oil Mills, Inc.
Expressed rapeseed oil: made by J-Oil Mills, Inc.
Degummed rapeseed oil: made by J-Oil Mills, Inc.
Deacidified rapeseed oil: made by J-Oil Mills, Inc.
Deacidified cottonseed oil: made by Okamoto Seiyu KK

(Preparation of Superheated Oil)

The expressed oil, extracted oil, degummed oil, or deacidified oil of the vegetable oil and fat was subjected to superheating treatment by being heated to normal temperature and, upon reaching 140° C., being kept at said temperature for 60 minutes to prepare the superheated oils indicated by A-1 to A-3 in table 1.

(Creation of Test Oil)

The superheated oils A-1 to A-3 of vegetable oils and fats that were prepared according to table 1 were incorporated into a base oil in amounts of 0.01-5 mass % to prepare test oils B-1 to B-3 and C-1 to C-5 in table 1.

TABLE 1

| | | | | Super- | | | | |
|---|---|---|---|---|---|---|---|---|
| | | | | heated | | | | |
| Oil and fat | | | | oil | | | | Test oil |
| Expressed | → | Super- | → | A-1 | → | Dilution | → | B-1 |
| oil or | | heating | | | | using | | |
| extracted | | treatment | | | | base oil | | |
| oil | | | | | | | | |
| ↓ | | | | | | | | |
| Degummed | → | Super- | → | A-2 | → | Dilution | → | B-2 |
| oil | | heating | | | | using | | |
| | | treatment | | | | base oil | | |
| ↓ | | | | | | | | |
| Deacidified | → | Super- | → | A-3 | → | Dilution | → | B-3, |
| oil | | heating | | | | using | | C-1 to |
| | | treatment | | | | base oil | | C-5 |

(Heating Test)

Each of the test oils was placed in 200-g amounts in a porcelain dish having a diameter of 24 cm and was heated at 180° C. for 16 hours. The chromaticity of the test oils after heating, in terms of each of the yellow chromaticity (Y value) and the red chromaticity (R value), was measured using a Lovibond chromometer (Lovibond PFX880, made by The Tintometer Ltd.) using one-inch cells. A base oil to which no superheated oil was added was employed as a control. The value of Y+10R was calculated using measured values to derive the chromaticity. The chromaticity of the test oils was divided by the chromaticity of the control to calculate respective coloration inhibition rates relative to the control.

(Coloration inhibition rate (%))={1−((chromaticity of test oil)/(chromaticity of control))}×100

(Test 1)

The heating test was carried out using canola oil as the base oil, and calculations were made with regard to the coloration inhibition rates for the test oils B-1 to B-3 containing 0.5 mass % of the superheated oils A-1 to A-3, respectively, relative to the control. As shown in table 2, a coloration-inhibiting effect was found to be exhibited by test oils B-2 and B-3 in the case of corn oil, all of test oils B-1 to B-3 in the case of soybean oil and rapeseed oil, and test oil B-3 in the case of cottonseed oil. In particular, the coloration-inhibiting effect was remarkably high in test oils B-2 and B-3 in the case of corn oil and in test oil B-1 in the case of soybean oil. According to the above results, it was understood that when canola oil is used as the base oil, the coloration-inhibiting effect was exhibited to a greater extent by the test oils containing superheated oil than by the control canola oil, which did not contain superheated oil.

TABLE 2

Coloration inhibition rate (%)
Vegetable oil and fat

| Test | Corn | Soybean | Rapeseed | Cottonseed |
|---|---|---|---|---|
| oil | oil | oil | oil | oil |
| B-1 | | 25.5 | 6.9 | |
| B-2 | 20.9 | 9.7 | 13.8 | |
| B-3 | 31.8 | 6.1 | 13.8 | 11.6 |

(Test 2)

The heating test was carried out using soybean oil as the base oil, and calculations were made with regard to the coloration inhibition rates for the test oils B-2 and B-3 containing 0.5 mass % of the superheated oils A-2 and A-3, respectively, relative to the control. As shown in table 3, a coloration-inhibiting effect was found to be exhibited by test oils B-2 and B-3 in the case of corn oil, soybean oil, and rapeseed oil, and test oil B-3 in the case of cottonseed oil. In particular, the coloration-inhibiting effect was remarkably high in test oil B-3 in the case of corn oil, soybean oil, and rapeseed oil. According to the above results, it was understood that when soybean oil is used as the base oil, the coloration-inhibiting effect was exhibited to a greater extent by the test oils containing superheated oil than by the control soybean oil, which did not contain superheated oil.

TABLE 3

Coloration inhibition rate (%)
Vegetable oil and fat

| Test | Corn | Soybean | Rapeseed | Cottonseed |
|---|---|---|---|---|
| oil | oil | oil | oil | oil |
| B-2 | 14.7 | 10.5 | 13.7 | |
| B-3 | 16.8 | 15.8 | 16.8 | 11.6 |

(Test 3)

The heating test was carried out using canola oil and soybean oil as base oils, test oils C-1 to C-5 containing 0.01-5 mass % of the corn-oil superheated oil A-3 in table 1 were prepared, and calculations were made with regard to the coloration inhibition rates for the test oils C-1 to C-5 relative to the control. Canola oil and soybean oil to which no superheated oil was added were each used as controls. As shown in table 4, a coloration-inhibiting effect was found to be exhibited by all of the test oils containing the corn-oil superheated oil A-3. In particular, the coloration-inhibiting effect was remarkably high in test oil C-3, which contained 0.5 mass % of the superheated oil A-3, when canola oil was used as the base oil, and in test oil C-2, which contained 0.1 mass % of the superheated oil A-3, when soybean oil was used as the base oil. According to the above results, it was understood that the coloration-inhibiting effect was exhibited to a greater extent by the test oils containing the corn-oil superheated oil A-3 than by the control, which did not contain superheated oil.

TABLE 4

| | Corn-oil | |
|---|---|---|
| | superheated oil | Coloration inhibition rate (%) |
| Test | A-3 concentration | Base oil |

| oil | (mass %) | Canola oil | Soybean oil |
|---|---|---|---|
| C-1 | 0.01 | 12.9 | 14.8 |
| C-2 | 0.1 | 12.9 | 21.3 |
| C-3 | 0.5 | 29.0 | 18.0 |
| C-4 | 1 | 11.3 | 11.5 |
| C-5 | 5 | 7.3 | 9.8 |

1. A coloration inhibitor characterized in containing, as an active ingredient, a heated oil obtained by implementing a heating treatment at 120° C. or higher on: an unrefined raw oil including an expressed oil of an oil and fat raw material, an extracted oil of the oil and fat raw material, or both the expressed oil and the extracted oil; or an oil and fat obtained by furthermore implementing degumming, deacidification, or both of these treatments on the unrefined raw oil.

2. The coloration inhibitor according to claim 1, containing, as an active ingredient, a heated oil obtained by furthermore implementing a refinement treatment on the heated oil after implementation of the heating treatment at 120° C. or higher.

3. The coloration inhibitor according to claim 1, wherein the oil and fat raw material is a vegetable oil and fat.

4. An edible oil and fat composition characterized in containing the coloration inhibitor according to claim 1.

5. A method for producing a coloration inhibitor, characterized in comprising a step for obtaining a heated oil by implementing a heating treatment at 120° C. or higher on: an unrefined raw oil including an expressed oil of an oil and fat raw material, an extracted oil of the oil and fat raw material, or both the expressed oil and the extracted oil; or an oil and fat obtained by furthermore implementing degumming, deacidification, or both of these treatments on the unrefined raw oil.

6. The method for producing a coloration inhibitor according to claim 5, comprising a step for furthermore implementing a refinement treatment on the heated oil after implementation of the heating treatment at 120° C. or higher.

7. The method for producing a coloration inhibitor according to claim 5, wherein the oil and fat raw material is a vegetable oil and fat.

8. A method for inhibiting coloration of a food product, characterized in that the coloration inhibitor according to claim 1 is used when producing a food product.

9. A method for inhibiting coloration of a food product, characterized in that the edible oil and fat composition according to claim 4 is used when producing a food product.
